(19) United States
(12) Patent Application Publication
(10) Pub. No.: US 2011/0025542 A1
(43) Pub. Date: Feb. 3, 2011

(54) Integration Interface of a Remote Control Toy and an Electronic Game

(76) Inventor: Shanker Mo, Wu-Chi Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/534,205

(22) Filed: Aug. 3, 2009

(51) Int. Cl. H04L 17/02

(52) U.S. Cl. 341/176

(57) ABSTRACT

An integration interface of a remote control toy and an electronic game includes an electronic equipment, at least one camera unit, an electronic monitor, an operation unit, a remote control signal output device, a horn, and a controlled object. Thus, when the operation unit inputs an operation signal into the electronic equipment, by decoding and calculation of the electronic equipment, the electronic equipment drives the remote control signal output device to transmit a wireless signal to drive and control movement of the remote control toy, so that the user or controller can operate the true toy on the electronic monitor so as to achieve a virtual reality amusement.

### BACKGROUND OF THE INVENTION

1. Field of the Invention

The present invention relates to an interface and, more particularly, to an integration interface of a remote control toy and an electronic game.

2. Description of the Related Art

A conventional remote control toy comprises a remote controller, a power actuating module and a signal receiving module. Thus, the remote controller transmits a wireless signal to the signal receiving module which drives the power actuating module which drives and controls movement of the remote control toy, so that the user can operate the remote control toy by control of the remote controller. However, the wireless signal of the remote controller has a determined range so that when the remote control toy exceeds the control range of the wireless signal of the remote controller, the remote controller cannot control the remote control toy any more. In addition, the remote control toy easily hits an obstruction during movement so that the remote control toy is easily damaged or worn when hitting the obstruction.

A conventional electronic game comprises a keyboard, a push button, a mouse, a rocker lever and a contact monitor. Thus, the player and the electronic game have a simulative interaction to achieve a playing amusement. However, the conventional electronic game cannot achieve a virtual reality purpose, thereby limiting the amusement effect.

### BRIEF SUMMARY OF THE INVENTION

In accordance with the present invention, there is provided an integration interface of a remote control toy and an electronic game, comprising an electronic equipment that can decode and calculate data of an input signal, can execute a logic operation according to preset parameters and can judge if to execute a command of a controller or to forcibly stop the command of the controller, at least one camera unit connected with the electronic equipment to transmit a video signal to the electronic equipment and including two cameras, an electronic monitor connected with the electronic equipment to receive a video signal transmitted by the electronic equipment and to indicate multiple divided operation windows, an operation unit connected with the electronic equipment to transmit an input signal to the electronic equipment, a remote control signal output device connected with the electronic equipment to transmit a remote control signal by a wireless transmission, a controlled object controlled by the remote control signal output device and having an inner portion containing a power actuating module and a signal receiving module, and a horn connected with the electronic equipment to transmit an audio signal during operation of the controlled object. The two cameras align with an operable zone that is defined by an overlapped portion of the viewing angles the two cameras and is reachable by the remote control signal of the remote control signal output device.

According to the primary objective of the present invention, the electronic equipment is provided with at least one camera unit which includes two cameras which are spaced from each other with a determined distance defined between the two cameras to produce a visual differential so that the electronic equipment can control the related position between the controlled object and the operable zone.

According to another objective of the present invention, at least two reference points are placed in the operable zone, and the physical information of the reference points is input into the electronic equipment, so that by decoding and calculation of the electronic equipment according to the input video data of the two cameras and the physical information of the reference points, the electronic equipment can obtain an absolute three-dimensional coordinate of the controlled object in the operable zone so as to limit the movement the controlled object.

According to a further objective of the present invention, when the operation unit inputs an operation signal into the electronic equipment, by decoding and calculation of the electronic equipment, the electronic equipment drives the remote control signal output device to transmit a wireless signal to the signal receiving module which drives the power actuating module which drives and controls movement of the remote control toy, so that the controller can operate the true toy on the electronic monitor so as to achieve a virtual reality amusement. At the same time, when the electronic equipment detects that the remote control toy reaches the border line of the operable zone or the obstruction, the electronic equipment transmits a forcible command to the remote control signal output device to return the remote control toy so that the movement of the remote control toy is limited in the operable zone to prevent the remote control toy from exceeding the operable zone and to prevent the remote control toy from hitting the obstruction.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of an integration interface of a remote control toy and an electronic game in accordance with the preferred embodiment of the present invention.

FIG. 2 is a schematic planar view of the integration interface of a remote control toy and an electronic game in accordance with the preferred embodiment of the present invention.

### DETAILED DESCRIPTION OF THE INVENTION

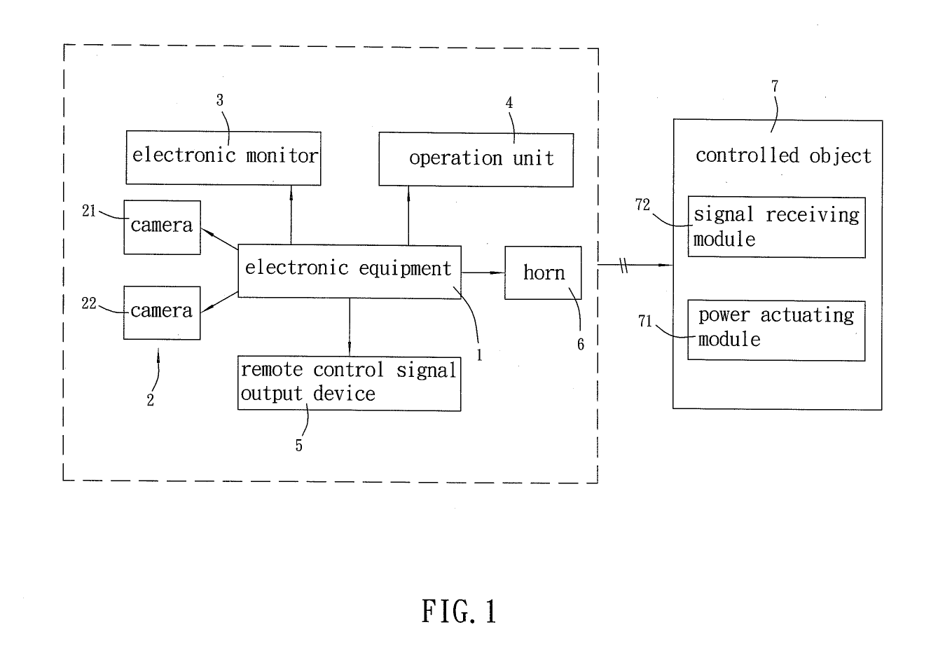

Referring to the drawings and initially to FIG. 1, an integration interface of a remote control toy and an electronic game in accordance with the preferred embodiment of the present invention comprises an electronic equipment 1, at least one camera unit 2, an electronic monitor 3, an operation unit 4, a remote control signal output device 5, a horn 6, and a controlled object 7.

The electronic equipment 1 is a central processor. The electronic equipment 1 can decode and calculate the data of an input signal and can execute a logic operation according to preset parameters. The electronic equipment 1 can also judge and directly execute the command of a controller. Alternatively, the electronic equipment 1 can also judge and forcibly stop the command of the controller so as to execute a forcible command under a preset condition.

The camera unit 2 is connected with the electronic equipment 1 to transmit a video signal to the electronic equipment 1. The camera unit 2 includes two cameras 21 and 22. The two cameras 21 and 22 of the camera unit 2 are spaced from each other, and most of the viewing angles of the two cameras 21 and 22 overlap each other.

The electronic monitor 3 is connected with the electronic equipment 1 to receive a video signal transmitted by the electronic equipment 1 and to indicate windows that are controllable instantly according to various purposes.

The operation unit 4 is connected with the electronic equipment 1 to transmit an input signal to the electronic equipment 1. Preferably, the operation unit 4 is a keyboard, push button, mouse, rocker lever or contact monitor.

The remote control signal output device 5 is connected with the electronic equipment 1 to transmit a remote control signal. Preferably, the remote control signal of the remote control signal output device 5 is a radio signal, an infrared signal or an audio controlled signal.

The horn 6 is connected with the electronic equipment 1 to transmit an audio signal.

The controlled object 7 is controlled by the remote control signal output device 5 and has an inner portion containing a power actuating module 71 and a signal receiving module 72. Preferably, the controlled object 7 is a remote control toy.

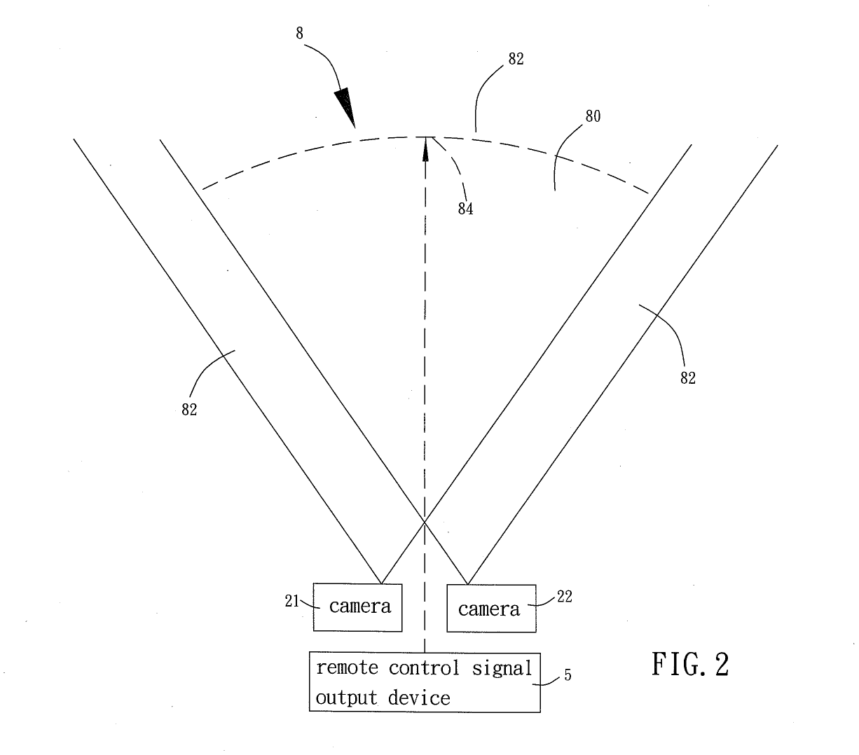

In practice, referring to FIG. 2 with reference to FIG. 1, the two cameras 21 and 22 of the camera unit 2 are spaced from each other and align with an operation space 8 simultaneously. Then, the electronic equipment 1 processes and executes an operation on the video signal from the two cameras 21 and 22 of the camera unit 2 to produce a related position coordinate between the controlled object 7 and the operation space 8, and the related position coordinate between the controlled object 7 and the operation space 8 is indicated on the electronic monitor 3. The related position coordinate between the controlled object 7 and the operation space 8 is a three-dimensional coordinate. The operation space 8 is defined by the viewing angles the two cameras 21 and 22. The operation space 8 consists of an operable zone 80 and a non-operable zone 82. The operable zone 80 of the operation space 8 is defined by an overlapped portion of the viewing angles the two cameras 21 and 22 and is reachable by the remote control signal of the remote control signal output device 5. Thus, the operable zone 80 of the operation space 8 has a sector shape and has a radius 84 that is equal to or smaller than the maximum distance of the remote control signal of the remote control signal output device 5. The non-operable zone 82 of the operation space 8 surrounds the operable zone 80. Thus, the related position coordinate between the controlled object 7 and the operation space 8 is limited in the operable zone 80 of the operation space 8.

In addition, at least two reference points are placed in the operable zone 80, and the physical information of the reference points is input into the electronic equipment 1. Then, the video signal of the two cameras 21 and 22 is input into the electronic equipment 1. At this time, the two cameras 21 and 22 of the camera unit 2 are spaced from each other with a determined distance defined between the two cameras 21 and 22 to produce a visual differential. Then, by decoding and calculation of the electronic equipment 1, the electronic equipment 1 can calculate the absolute three-dimensional coordinate of the controlled object 7 in the operable zone 80 of the operation space 8. The electronic equipment 1 can also transmit the coordinate of the controlled object 7 to the electronic monitor 3 simultaneously so that the coordinate of the controlled object 7 is indicated in a specific window of the electronic monitor 3. Thus, the electronic monitor 3 has a virtual reality function to indicate the operation space 8, and the related dynamic position of the controlled object 7 is presented in the window of the electronic monitor 3 simultaneously so that the controller can control the controlled object 7 easily by a sufficient information.

In addition, the minimum gyration radius of the controlled object 7 is input into the electronic equipment 1. In such a manner, when the electronic equipment 1 detects that the controlled object 7 reaches the border line of the operable zone 80, the electronic equipment 1 instantly executes an operation and transmits a forcible command to the remote control signal output device 5 which transmits a wireless signal to the signal receiving module 72 which drives the power actuating module 71 which drives and controls movement of the controlled object 7 so that the movement of the controlled object 7 is limited in the operable zone 80 to prevent the controlled object 7 from exceeding the operable zone 80. Thus, the electronic equipment 1 can control the velocity, speed and moving direction of the controlled object 7 so as to forcibly limit the controlled object 7 to move in the operable zone 80.

Alternatively, when the controlled object 7 is moved in the operable zone 80, the controller can select a hand-control mode to control the controlled object 7 by himself. At this time, the electronic equipment 1 can also control the movement of the controlled object 7 to prevent the controlled object 7 from exceeding the operable zone 80.

Alternatively, the controller can also select an auto-control mode to control the controlled object 7 automatically. In such a manner, the electronic equipment 1 produces random values to adjust kinematical parameters (such as the values of acceleration, deceleration, direction, gyration radius, forward movement, backward movement, ascending, descending and the like) of the controlled object 7 and to further control the moving manner of the controlled object 7 so that the controlled object 7 is moving in the operable zone 80 in a helical, winding, uni-directional or non-directional manner. At this time, the absolute three-dimensional coordinate and the minimum gyration radius of the controlled object 7 are stored in the electronic equipment 1 previously so that when the controlled object 7 reaches the border line of the operable zone 80, the electronic equipment 1 transmits a forcible command to decelerate, turning, lifting or lowering the controlled object 7 so as to return the controlled object 7 and to prevent the controlled object 7 from exceeding the operable zone 80.

Thus, the two cameras 21 and 22 transmit a three-dimensional video signal to the electronic equipment 1 so that the electronic equipment 1 can identify the three-dimensional coordinate of the controlled object 7 in the operable zone 80. In addition, an obstruction (such as tree, telegraph pole, house, wall, ceiling and the like) in the operable zone 80 is indicated in the window of the electronic monitor 3 previously, and the coordinate of the obstruction is calculated by the electronic equipment 1 so that the electronic equipment 1 transmits a forcible command to return the controlled object 7 to evade the obstruction automatically so as to prevent the controlled object 7 from hitting the obstruction in the operable zone 80.

In addition, when different mechanical features (such as air freighter, air fighter, combat car, truck, sports car, train, robot and the like) of the controlled object 7 are input into the electronic equipment 1, the electronic equipment 1 transmits a command to the horn 6 so that the horn 6 transmits an audio signal to simulate the sound of the controlled object 7. Besides, the electronic equipment 1 produces a sound variation signal according to the variation of kinematical parameters during movement of the controlled object 7 and transmits the sound variation signal to the horn 6 so that the horn 6 transmits an audio signal to simulate a sound variation of the controlled object 7 during movement according to different kinematical modes and velocities (such as braking, accelerating, decelerating, idling, ascending, descending, stalling and the like) of the controlled object 7. Thus, the horn 6 can simulate the respective mechanical sound effect of the controlled object 7 and simulate different sound variation effects during movement of the controlled object 7 so as to provide a lively function and a greater amusement.

Alternatively, the electronic equipment 1 presets a warning line which is close to the obstruction in the operable zone 80 or the border line of the operable zone 80. Thus, when the electronic equipment 1 detects that the controlled object 7 reaches the warning line, the electronic equipment 1 transmits a command to the horn 6 so that the horn 6 transmits a warning sound so as to notify the controller. Besides, when the controlled object 7 hits the obstruction, the horn 6 is controlled by the electronic equipment 1 to emit a larger sound to present a shock sounding effect to enhance the amusement.

Alternatively, the integration interface comprises at least two camera units 2. The at least two camera units 2 are arranged in a concentric manner to increase the number of the operable zone 80. It is to be noted that, the operable zones 80 of different camera units 2 are connected with each other so that the controlled object 7 can freely pass through the operable zones 80 of different camera units 2 so as to enlarge the field of the operable zones 80. At the same time, the electronic monitor 3 has at least two windows corresponding to the operable zones 80 of the at least two camera units 2 to control the operable zones 80 of the at least two camera units 2 respectively. Alternatively, the electronic monitor 3 has an integrated window to control the operable zones 80 of the at least two camera units 2.

In addition, the operation window of the electronic monitor 3 is controlled by the electronic equipment 1 to indicate a travel path of the controlled object 7 so that the controlled object 7 is controlled by the electronic equipment 1 to move along the travel path automatically. When the controlled object 7 is a sports car, the travel path is a race track. Alternatively, when the controlled object 7 is a flight vehicle, the travel path is a flight path so that the controlled object 7 can take off, ascend, circle, descend and land along the travel path.

In addition, the operation unit 4 has function keys to operate and control at least two controlled objects 7 which are controlled by at least two different remote control signal output devices 5 and are moved in the same operable zone 80. At this time, at least two controllers can operate the at least two controlled objects 7 to compete with each other. Alternatively, a single controller can compete with the electronic equipment 1. Alternatively, the at least two controlled objects 7 are controlled by the electronic equipment 1 to compete with each other, and the controller does not join the race.

In addition, the background (racing field, air fight field, airport and the like) of the window of the electronic monitor 3 is selected and switched by the controller to change the tedious three-dimensional coordinate into a live field. Besides, the mechanical figuration (sports car, air fighter and the like) of the controlled object 7 is indicated in the window of the electronic monitor 3 to provide a lively amusement to the controller. Besides, the background of the window of the electronic monitor 3 is selected from the two cameras 21 and 22.

In addition, the scene of the window of the electronic monitor 3 is taken from a position in front of the two cameras 21 and 22. Alternatively, the scene of the window of the electronic monitor 3 is taken from a position of the controlled object 7. Alternatively, the scene of the window of the electronic monitor 3 is taken from a reference point in the operable zone 80, and the reference point is directed toward the moving controlled object 7.

In conclusion, the two cameras 21 and 22 align with the operation space 8 simultaneously, the video signal of the two cameras 21 and 22 is input into the electronic equipment 1, and the two cameras 21 and 22 are spaced from each other with a determined distance defined between the two cameras 21 and 22 to produce a visual differential. Then, at least two reference points are placed in the operable zone 80, and the physical information of the reference points is input into the electronic equipment 1. Then, by decoding and calculation of the electronic equipment 1, the electronic equipment 1 calculates the absolute three-dimensional coordinate of the controlled object 7 in the operable zone 80 of the operation space 8 and transmits the coordinate of the controlled object 7 to the electronic monitor 3 simultaneously to indicate the coordinate of the controlled object 7 in the window of the electronic monitor 3 so that the electronic monitor 3 has a virtual reality function to indicate the operation space 8 and the related position of the controlled object 7 to facilitate the controller controlling the controlled object 7. In addition, the minimum gyration radius of the controlled object 7 is input into the electronic equipment 1 so that the operation unit 4 can control operation of the controlled object 7, and the electronic equipment 1 can transmit a forcible command to the remote control signal output device 5 to limit movement of the controlled object 7 in the operable zone 80 so as to prevent the controlled object 7 from exceeding the operable zone 80.

Accordingly, the electronic monitor 3 has a virtual reality function to simultaneously indicate the fantasy operation space 8 and the related fantasy position of the controlled object 7 that are similar to the reality so that the integration interface combine the function of a remote control toy and an electronic game.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An integration interface of a remote control toy and an electronic game, comprising:
an electronic equipment that can decode and calculate data of an input signal, can execute a logic operation according to preset parameters and can judge if to execute a command of a controller or to forcibly stop the command of the controller;
at least one camera unit connected with the electronic equipment to transmit a video signal to the electronic equipment and including two cameras;
an electronic monitor connected with the electronic equipment to receive a video signal transmitted by the electronic equipment and to indicate multiple divided operation windows;
an operation unit connected with the electronic equipment to transmit an input signal to the electronic equipment;
a remote control signal output device connected with the electronic equipment to transmit a remote control signal by a wireless transmission;
a controlled object controlled by the remote control signal output device and having an inner portion containing a power actuating module and a signal receiving module;
a horn connected with the electronic equipment to transmit an audio signal during operation of the controlled object.

2. The integration interface of a remote control toy and an electronic game of claim 1, wherein
the electronic equipment can judge and directly execute the command of the controller;
the electronic equipment can judge and forcibly stop the command of the controller so as to execute a forcible command under a preset condition.

3. The integration interface of a remote control toy and an electronic game of claim 1, wherein the two cameras of the camera unit are spaced from each other.

4. The integration interface of a remote control toy and an electronic game of claim 1, wherein the two cameras of the camera unit have viewing angles that are parallel with each other.

5. The integration interface of a remote control toy and an electronic game of claim 1, wherein the two cameras of the camera unit have viewing angles that are non-parallel with each other.

6. The integration interface of a remote control toy and an electronic game of claim 1, wherein the two cameras align with an operable zone that is defined by an overlapped portion of the viewing angles the two cameras and is reachable by the remote control signal of the remote control signal output device.

7. The integration interface of a remote control toy and an electronic game of claim 6, wherein the operable zone has a sector shape and has a radius that is equal to or smaller than an effective distance of the remote control signal of the remote control signal output device.

8. The integration interface of a remote control toy and an electronic game of claim 1, wherein
the operation windows of the electronic monitor have pictures that are taken from the two cameras;
the operation windows of the electronic monitor can be switched into a fantasy space coordinate or a fantasy scene which is taken from a position in front of the two cameras.

9. The integration interface of a remote control toy and an electronic game of claim 8, wherein the fantasy scene of the operation windows of the electronic monitor is taken from a position of the controlled object.

10. The integration interface of a remote control toy and an electronic game of claim 8, wherein the fantasy scene of the operation windows of the electronic monitor is taken from a reference point in the operable zone, and the reference point is directed toward the moving controlled object.

11. The integration interface of a remote control toy and an electronic game of claim 1, wherein the integration interface comprises a single camera unit.

12. The integration interface of a remote control toy and an electronic game of claim 1, wherein the integration interface comprises at least two camera units.

13. The integration interface of a remote control toy and an electronic game of claim 12, wherein the at least two camera units are arranged in a concentric manner.

14. The integration interface of a remote control toy and an electronic game of claim 12, wherein the at least two camera units are arranged in a non-concentric manner.

15. The integration interface of a remote control toy and an electronic game of claim 1, wherein the operation unit is a keyboard, push button, mouse, rocker lever or contact monitor.

16. The integration interface of a remote control toy and an electronic game of claim 1, wherein the operation windows of the electronic monitor are controlled by the electronic equipment to indicate a travel path of the controlled object so that the controlled object is controlled by the electronic equipment to move along the travel path automatically.

17. The integration interface of a remote control toy and an electronic game of claim 1, wherein the operation unit has function keys to operate and control at least two controlled objects which are controlled by at least two different remote control signal output devices and are moved in the same operable zone.

18. The integration interface of a remote control toy and an electronic game of claim 17, wherein
at least two controllers can operate the at least two controlled objects to compete with each other;
a single controller can compete with the electronic equipment;
the at least two controlled objects are controlled by the electronic equipment to compete with each other.

19. The integration interface of a remote control toy and an electronic game of claim 1, wherein the operation unit has function keys to operate and control at least two controlled objects which are controlled by at least two different remote control signal output devices and are moved in at least two operable zones.

20. The integration interface of a remote control toy and an electronic game of claim 19, wherein
at least two controllers can operate the at least two controlled objects to compete with each other;
a single controller can compete with the electronic equipment;
the at least two controlled objects are controlled by the electronic equipment to compete with each other.

21. The integration interface of a remote control toy and an electronic game of claim 1, wherein
at least two controlled objects are operated in the operable zone;
the at least two controlled objects are controlled by at least two electronic equipments, at least two camera units, at least two electronic monitors, at least two operation units, at least two remote control signal output devices and at least two horns.

22. The integration interface of a remote control toy and an electronic game of claim 1, wherein the electronic equipment transmits a command to the horn according to a mechanical feature, a kinematical mode variation, a warning state and a hitting condition of the controlled object so that the horn transmits an audio signal to simulate the sound of the controlled object.
